(19) United States
(12) Patent Application Publication
(10) Pub. No.: US 2014/0358532 A1
(43) Pub. Date: Dec. 4, 2014

(54) METHOD AND SYSTEM FOR ACOUSTIC CHANNEL INFORMATION DETECTION

(71) Applicant: AIROHA TECHNOLOGY CORP., HSINCHU (TW)

(72) Inventor: HENG-CHIH LIN, HSINCHU (TW)

(73) Assignee: AIROHA TECHNOLOGY CORP., HSINCHU (TW)

(21) Appl. No.: 14/282,104

(22) Filed: May 20, 2014

Related U.S. Application Data
(60) Provisional application No. 61/830,209, filed on Jun. 3, 2013.

(51) Int. Cl. G10L 19/012

(52) U.S. Cl. CPC G10L 19/012
USPC 704/226

(57) ABSTRACT

A method or a system for acoustic channel information detection includes at least one speaker and at least one microphone within an environment. The microphone receives a CDMA modulated audio training signal from the speaker via a plurality of acoustic channels within the environment, wherein the CDMA modulated audio training signal is a pre-known CDMA modulated audio training signal, and comprises a data signal, a spreading code and/or a continuous frequency code. Thus, the microphone is able to estimate the acoustic channel information including frequency dependence according to the received CDMA modulated audio training signal and the pre-known CDMA modulated audio training signal.

### REFERENCE TO RELATED APPLICATION

This Application is based on Provisional Application Ser. No. 61/830,209, filed 3 Jun. 2013, currently pending.

### BACKGROUND OF THE INVENTION

1. Technical Field

The present invention is relative to a method and a system for detecting the acoustic channel information.

2. Description of the Prior Art

Referring to FIG. 1, it shows a communication device with a microphone and a speaker within an environment. As illustrated, the communication device 10, such as a mobile phone, a computer, a notebook, a handsfree, teleconferencing systems or a surrounding sound system, comprises at least one speaker 11 and at least one microphone 13. The speaker 11 of the communication device 10 is able to transmit an acoustic signal to a user 14, and the microphone 13 of the communication device 10 is able to receive another acoustic signal from the user 14.

The user 14 and the communication device 10 are located in an environment 100, such as room, automobile interior or open space. As the user 14 speaks, the microphone 13 is capable of receiving the acoustic signal from the user 14 via a plurality of acoustic channels 15, such as the first acoustic channel 151, the second acoustic channel 153 and the third acoustic channel 155, within the environment 100. As the speaker 11 generates another acoustic signal, the user 14 will receive the acoustic signal from the speaker 11. Further, the microphone 13 will also receive the acoustic signal from the speaker 11 via a plurality of acoustic channels 15, such as the fourth acoustic channel 157 and the fifth acoustic channel 159, within the environment 100.

The distances of acoustic channels 15, such as the first acoustic channel 151, the second acoustic channel 153, the third acoustic channel 155, the fourth acoustic channel 157 and the fifth acoustic channel 159, are different which causes echo, and lowers the voice quality of the communication device 10.

### SUMMARY OF THE PRESENT INVENTION

It is, therefore, the main object of the present invention to provide a system and a method for detecting the acoustic channel information, which comprises at least one speaker and at least one microphone within an environment. The speaker is capable of transmitting a CDMA modulated audio training signal, and the microphone is capable of receiving the CDMA modulated audio training signal via a plurality of acoustic channels within the environment to estimate the acoustic channel information of the environment. Thus, phase mismatch, frequency response mismatch, linear echo, nonlinear echo, noise and active noise of the environment can be estimated and cancelled according to the acoustic channel information.

It is another object of the present invention to provide a system and a method for detecting the acoustic channel information, which comprises at least one speaker and at least one microphone within an environment. The microphone receives a CDMA modulated audio training signal from the speaker via a plurality of acoustic channels within the environment, wherein the CDMA modulated audio training signal comprises a data signal, a spreading code and a continuous frequency code. Thus, frequency dependent magnitude response of acoustic channels within the environment can be estimated, and the necessary equalization can be done accordingly.

It is another object of the present invention to provide a system and a method for detecting the acoustic channel information, which comprises at least one speaker and at least one microphone within an environment. The microphone receives a CDMA modulated audio training signal from the speaker via a plurality of acoustic channels within the environment, wherein the CDMA modulated audio training signal comprises a data signal, a plurality of orthogonal spreading codes and a continuous frequency code. Thus, nonlinearly echo of acoustic channels within the environment can be estimated, and nonlinearly echo can be cancelled accordingly.

It is another object of the present invention to provide a system and a method for detecting the acoustic channel information, which comprises at least one speaker and at least one microphone integrated into a same device, such as a mobile phone, a smart phone, a computer, a notebook, a handsfree, teleconferencing systems or a surrounding sound system. The microphone is able to receive a CDMA modulated audio training signal from the speaker via a plurality of acoustic channels within the environment. Thus, the acoustic channel information can be estimated, and phase mismatch, frequency response mismatch, linear echo, nonlinear echo, noise and active noise of the environment can be detected and cancelled according to the acoustic channel information.

It is another object of the present invention to provide a system and a method for detecting the acoustic channel information, which comprises at least one speaker and at least one microphone integrated into a portable device, such as a mobile phone, a computer, a notebook or a handsfree. The environment of the speaker and the microphone may change with time. Thus, the speaker is able to transmit the CDMA modulated audio training signal on fixed time intervals, and the microphone is able to estimate the acoustic channel information accordingly to improve the voice quality of the portable device.

To achieve these and other objects of the present invention, the present invention provides a system for acoustic channel information detection, comprising: at least speaker located in an environment for transmitting a CDMA modulated audio training signal, and at least one microphone located in the environment for receiving the CDMA modulated audio training signal from the speaker via at least one acoustic channel within the environment to estimate an associated acoustic channel information according to the received the CDMA modulated audio training signal.

Further, the present invention provides a method for acoustic channel information detection, wherein there are at least one microphone, at least one speaker and a plurality of acoustic channels within an environment, comprising steps of: transmitting a CDMA modulated audio training signal by the speaker; receiving the CDMA modulated audio training signal by the microphone from the speaker via the acoustic channels, and estimating an acoustic channel information according to the received CDMA modulated audio training signal.

In one embodiment of the system or the method for acoustic channel information detection, the microphone comprises a pre-known CDMA modulated audio training signal, and the microphone compares the received CDMA modulated audio training signal with the pre-know CDMA modulated audio training signal to estimate the acoustic channel information.

In one embodiment of the system or the method for acoustic channel information detection, comprises the step of: comparing the received CDMA modulated audio training signal with the known CDMA modulated audio training signal.

In one embodiment of the system or the method for acoustic channel information detection, the CDMA modulated audio training signal comprises a data signal and a spreading code.

In one embodiment of the system for acoustic channel information detection, the speaker uses the spreading code to modulate the data signal, and the microphone uses the spreading code to demodulate the CDMA modulated audio training signal.

In one embodiment of the method for acoustic channel information detection, further comprises steps of: modulating the data signal by the spreading code to form the CDMA modulated audio training signal, and demodulating the received CDMA modulated audio training signal by the spreading code.

In one embodiment of the system or the method for acoustic channel information detection, the CDMA modulated audio training signal comprises a data signal, a spreading code and a continuous frequency code.

In one embodiment of the system for acoustic channel information detection, the speaker uses the spreading code and the continuous frequency code to modulate the data signal, and the microphone uses the spreading code and the continuous frequency code to demodulate the CDMA modulated audio training signal.

In one embodiment of the method for acoustic channel information detection, further comprises steps of: modulating the data signal by the spreading code and the continuous frequency code to form the CDMA modulated audio training signal, and demodulating the received CDMA modulated audio training signal by the spreading code and the continuous frequency code.

In one embodiment of the system or the method for acoustic channel information detection, the CDMA modulated audio training signal comprises a data signal, a plurality of orthogonal spreading codes and a continuous frequency code.

In one embodiment of the system for acoustic channel information detection, the speaker uses the orthogonal spreading codes and the continuous frequency code to modulate the data signal, and the microphone uses the orthogonal spreading codes and the continuous frequency code to demodulate the CDMA modulated audio training signal.

In one embodiment of the method for acoustic channel information detection, further comprises steps of: modulating the data signal by the a plurality of orthogonal spreading codes and the continuous frequency code to form the CDMA modulated audio training signal, and demodulating the received CDMA modulated audio training signal by the a plurality of orthogonal spreading codes and the continuous frequency code.

In one embodiment of the system or the method for acoustic channel information detection, the signal energy of the CDMA modulated audio training signal is below the noise floor and inaudible to human ear, or audible to human ear.

In one embodiment of the system or the method for acoustic channel information detection, the speaker transmits the CDMA modulated audio training signal to the microphone by wire or wireless.

In one embodiment of the system or the method for acoustic channel information detection, the microphone comprises a rake receiver to demodulate the received CDMA modulated audio training signal to know the phase and the phase delay of the received CDMA modulated audio training signal.

Other advantages and features of the present invention will be fully understood by reference to the following specification in conjunction with the accompanying drawings, in which like reference signs denote like components of structure.

### BRIEF DESCRIPTION OF THE DRAWINGS

Features and advantages of the method and the system of the present invention will be more fully appreciated by reference to the following detailed description of presently preferred but nonetheless illustrative embodiments in accordance with the present invention when taken in conjunction with the accompanying drawings in which:

FIG. 1 shows a block diagram of a communication device with a microphone and a speaker within an environment.

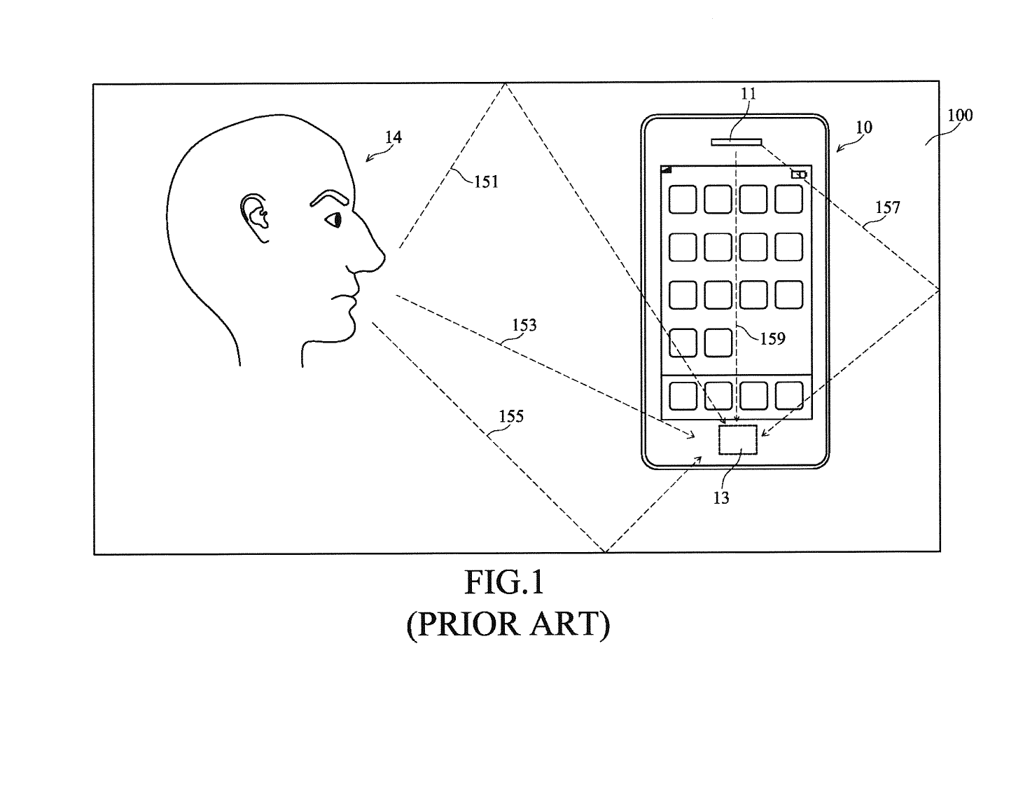

FIG. 2 shows a block diagram of a system for acoustic channel information detection.

FIG. 3 shows a flow chart of a method for acoustic channel information detection in accordance with an embodiment of the present invention.

FIG. 4 shows a sequence diagram for a CDMA modulated audio training signal in accordance with an embodiment of the present invention.

FIG. 5 shows a block diagram of a system for acoustic channel information detection in accordance with another embodiment of the present invention.

FIG. 6 shows a block diagram of a system for acoustic channel information detection in accordance with another embodiment of the present invention.

FIG. 7 shows a block diagram of a system for acoustic channel information detection in accordance with another embodiment of the present invention.

FIG. 8 shows a sequence diagram for a CDMA modulated audio training signal in accordance with another embodiment of the present invention.

FIG. 9 shows a block diagram of a system for acoustic channel information detection in accordance with another embodiment of the present invention.

FIG. 10 shows a block diagram of a system for acoustic channel information detection in accordance with another embodiment of the present invention.

### DETAILED DESCRIPTION OF THE PREFERRED EMBODIMENTS

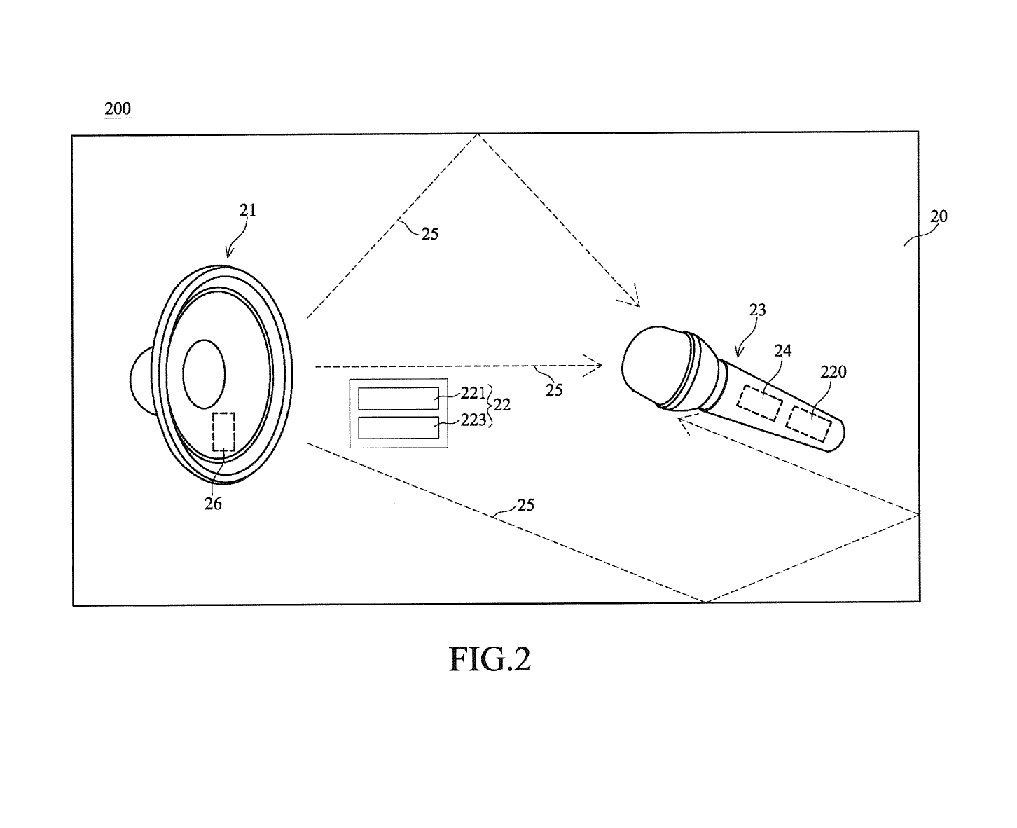

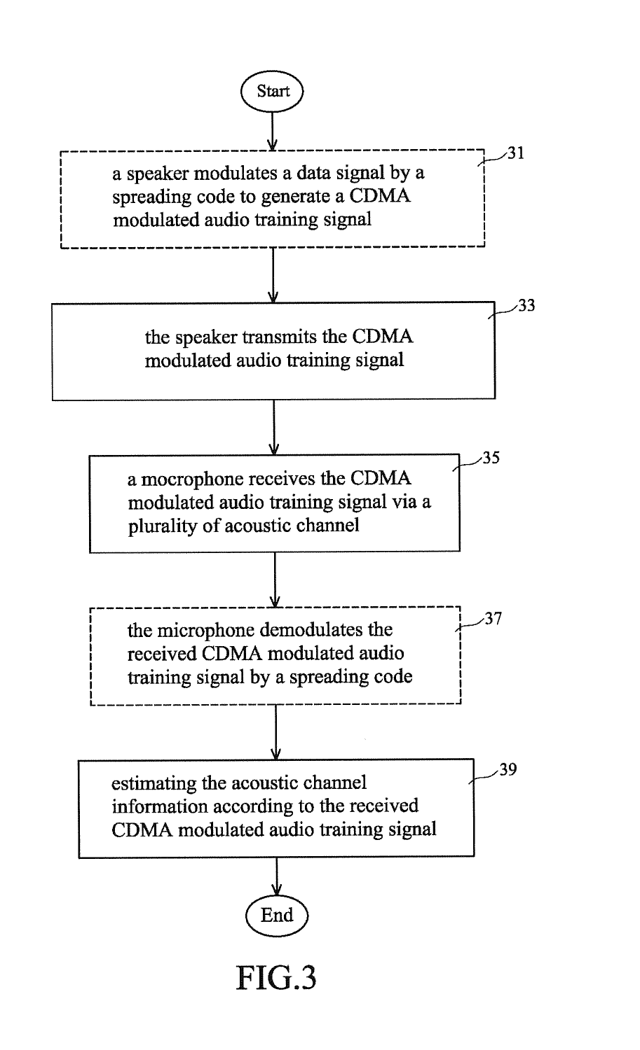

Please referring to FIG. 2 and FIG. 3 respectively, they show a block diagram of a system for acoustic channel information detection and a flow chart of a method for acoustic channel information detection in accordance with an embodiment of the present invention. As illustrated, the detection system 200 comprises, but not limited to, at least one speaker 21 and at least one microphone 23, wherein the speaker 21 and the microphone 23 are located in an environment 20, such as room, automobile interior or open space. The speaker 21 is capable of generating at least one acoustic signal, and the microphone 23 is capable of receiving at least one acoustic signal.

There are multi-acoustic channels 25 between the speaker 21 and the microphone 23 within the environment 20. During detection of the acoustic channel information between the speaker 21 and the microphone 23 within the environment 20, the speaker 21 first generates and transmits a CDMA modulated audio training signal 22, as the step 33. Thereafter, the microphone 23 receives the CDMA modulated audio training signal 22 via a plurality of acoustic channels 25 within the environment 20, as the step 35.

The CDMA modulated audio training signal 22 is a pre-known signal for the microphone 23 and/or the speaker 21. For example, the microphone 23 and/or the speaker 21 comprise a pre-know CDMA modulated audio training signal 220.

As the microphone 23 receives the CDMA modulated audio training signal 22 via acoustic channels 25, the microphone 23 is able to estimate the acoustic channel information between the speaker 21 and the microphone 23 within the environment 20 according to the received CDMA modulated audio training signal 22 and the pre-known CDMA modulated audio training signal 220. For example, the CDMA modulated audio training signal 22 received by the microphone 23 via acoustic channels 25 may be different from the pre-known CDMA modulated audio training signal 220 due to echo, noise and/or frequency response, and the microphone 23 is able to estimate the acoustic channel information by comparing the received CDMA modulated audio training signal 22 with the pre-known CDMA modulated audio training signal 220, as the step 39.

In one embodiment of the invention, the pre-known CDMA modulated audio training signal 220 may be stored in the microphone 23 beforehand, and then the microphone 23 is able to compare the received CDMA modulated audio training signal 22 with the pre-known CDMA modulated audio training signal 220 to estimate the acoustic channel information. Alternatively, the pre-known CDMA modulated audio training signal 220 is transmitted to the microphone 23 and/or the speaker 21 by wire or wireless. For example, the speaker 21 is able to connect to the microphone 23 via a connecting wire for transmitting the pre-know CDMA modulated audio training signal 220 to the microphone 23.

The CDMA modulated audio training signal 22 can be an audible audio signal or an inaudible audio signal. In one embodiment of the invention, the signal energy of the CDMA modulated audio training signal 22 is below the noise floor and inaudible to human ear. Thus, as the speaker 21 transmits the acoustic signal and the CDMA modulated audio training signal 22 at the same time, the user (human) only hears the acoustic signal, such that the speaker 21 and the microphone 23 are able to detect information of acoustic channels 25 at anytime and anyplace without influencing the function of the speaker 21 and the microphone 23. Alternatively, before using the speaker 21 and the microphone 23, the speaker 21 is able to transmit an audible CDMA modulated audio training signal 22 to the microphone 23, and the microphone 23 is able to estimate the acoustic channel information faster.

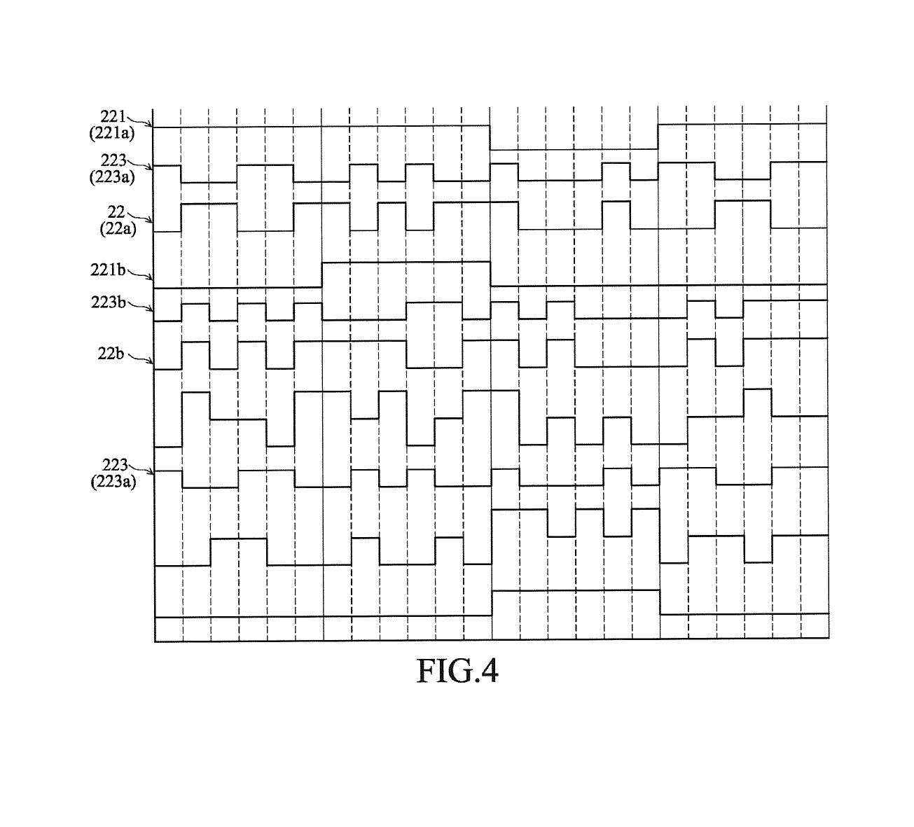

In one embodiment of the invention, please referring to FIG. 4, the CDMA modulated audio training signal 22 received by the microphone 23 via acoustic channels 25 comprises, but not limited to, a data signal 221 and a spreading code 223, such as pseudo-random or pseudo-noise (PN) sequences. The speaker 21 modulates the data signal 221 by the spreading code 223 to generate the CDMA modulated audio training signal 22, as the step 31. For example, the speaker 21 may comprise, but not limited to, a CDMA modulation unit 26 that is able to modulate the data signal 221 by the spreading code 223 to generate the CDMA modulated audio training signal 22. The microphone 23 receives the CDMA modulated audio training signal 22 via acoustic channels 25, and demodulates the received CDMA modulated audio training signal 22, as the step 37. For example, the microphone 23 demodulates the received CDMA modulated audio training signal 22 by the spreading code 223 to form the data signal 221. Moreover, the microphone 23 is capable of estimating the acoustic channel information between the speaker 21 and the microphone 23 within the environment 20 according to the CDMA modulated audio training signal 22 and the pre-known CDMA modulated audio training signal 220.

In one embodiment of the invention, the speaker 21 is able to generate and transmit the acoustic signal and the CDMA modulated audio training signal 22 at the some time, and the microphone 23 is able to receive the acoustic signal and the CDMA modulated audio training signal 22 at the same time. The microphone 23 is able to use the pre-known spreading code 223 to demodulate the received acoustic signal and the CDMA modulated audio training signal 22 to generate the data signal 221, wherein the acoustic signal will be filtered. Thus, the acoustic channel information between the speaker 21 and the microphone 23 can be estimated during use of the speaker 21 and microphone 23.

In one embodiment of the invention, the microphone 23 may comprises, but not limited to, a rake receiver 24, wherein the rake receiver 24 is able to demodulate the received CDMA modulated audio training signal 22 to know the phase and the phase delay of the received CDMA modulated audio training signal 22. For example, the rake receiver 24 comprises a plurality of same spreading codes 233 with different phase, and only one of spreading codes 233 is capable of demodulating the received CDMA modulated audio training signal 22. Further, the rake receiver 24 and/or the microphone 23 is able to know the phase and the phase delay of the received CDMA modulated audio training signal 22 according to the spreading code 233 used to demodulate the received CDMA modulated audio training signal 22.

In one embodiment of the invention, the speaker 21 and the microphone 23 may be integrated into a portable device, such as a mobile phone, a computer, a notebook or a handsfree. As the portable device with the speaker 21 and the microphone 23 is moved with a user, the environment 20 and the acoustic channel information between the speaker 21 and the microphone 23 will be changed accordingly. Thus, the acoustic channel information detection should be proceeded on fixed time intervals to improve the voice quality of the portable device with the speaker 21 and the microphone 23. For example, the speaker 21 is able to transmit the CDMA modulated audio training signal 22 during a fixed time interval, and then the microphone 23 is able to estimate the acoustic channel information accordingly.

After the acoustic channel information is estimated, it is easy to adjust the speaker 21 and/or the microphone 23 to improve the voice quality. For example, estimated the acoustic channel information can be used for various acoustic performance enhancement comprising, but not limited to, phase mismatch compensation, frequency response mismatch compensation, acoustic linear echo cancellation, acoustic nonlinear echo cancellation, acoustic noise reduction, multiple microphones acoustic gain and delay calibration and acoustic active noise cancellation.

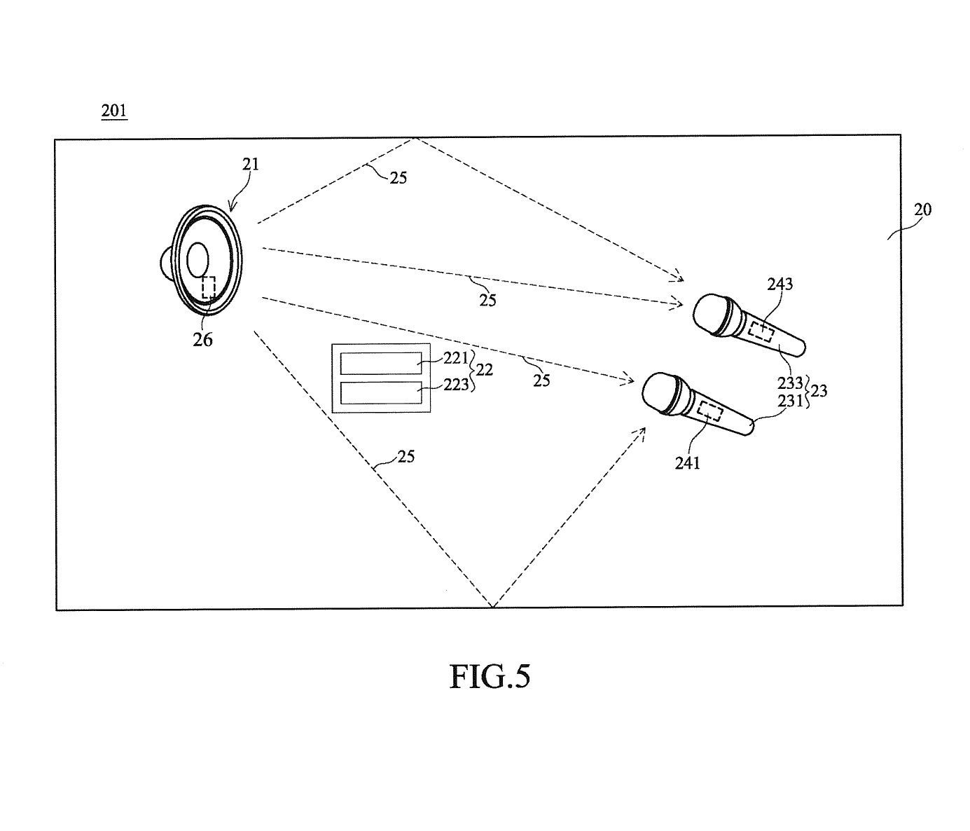

Please referring to FIG. 5, it shows a block diagram of a system for acoustic channel information detection in accordance with another embodiment of the present invention. As illustrated, the detection system 201 comprises, but not limited to, at least one speaker 21, a plurality of microphones 23 and a plurality of acoustic channels 25 within the environment 20, such as room, automobile interior or open space.

In one embodiment of the invention, the speaker 21 may comprise, but not limited to, a CDMA modulation unit 26 that is able to modulate the data signal 221 by the spreading code 223 to generate the CDMA modulated audio training signal 22. Further, each microphone 23 may comprise, but not limited to, a rake receiver 241/243, wherein the rake receiver 241/243 is able to demodulate the received CDMA modulated audio training signal 22 to know the phase and the phase delay of the received CDMA modulated audio training signal 22. For example, the rake receiver 241/243 comprises a plurality of same spreading codes 233 with different phase, and only one of spreading codes 233 is capable of demodulating the received CDMA modulated audio training signal 22. Thereafter, the rake receiver 241/243 is able to know the phase and the phase delay of the received CDMA modulated audio training signal 22 according to the spreading code 233 that is used to demodulate the received CDMA modulated audio training signal 22.

In one embodiment of the invention, the speaker 21 and/or microphones 23 may be integrated into a same device, such as a mobile phone, a smart phone, a computer, a notebook, a handsfree, teleconferencing systems or a surrounding sound system. The distance of each microphone 23 may be fixed, and the distance of the speaker 21 and microphones 23 may be fixed too. Thus, phase difference or relative phases of each microphone 23 should be fixed. However, the response time of microphones 23 will be changed due to aging, which causes phase mismatch. In this embodiment, the relative phase and the phase mismatch of microphones 23 can be known according to the spreading code 223 that is capable of demodulating the received CDMA modulated audio training signal 22, and thus the phase mismatch of a plurality of microphones 23 can be compensated. For example, the first microphone 231 comprises a first rake receiver 241, and the second microphone 233 comprises a second rake receiver 243. Initially, the first rake receiver 241 of the first microphone 231 may use the third spreading code 223 to demodulate the received CDMA modulated audio training signal 22, and the second rake receiver 243 of the second microphone 233 may use the fifth spreading code 223 to demodulate the received CDMA modulated audio training signal 22, wherein the time interval between the third spreading code 223 and the fifth spreading code 223 is T1. With the aging of the microphone 23, the first rake receiver 241 of the first microphone 231 may use the third spreading code 223 to demodulate the received CDMA modulated audio training signal 22, and the second rake receiver 243 of the second microphone 233 may use the seventh spreading code 223 to demodulate CDMA modulated audio training signal 22, wherein the time interval of the third spreading code 223 and the seventh spreading code 223 is T2. Thus, the change of response time of the first microphone 231 and the second microphone 233 due to the aging can be calculated according to T1, T2 and distance between the first microphone 231 and the second microphone 233.

Moreover, after microphones phase mismatch is estimated and/or compensated, it is easier to do microphones 23 receiving beam-forming thus reducing the receiving environmental noise.

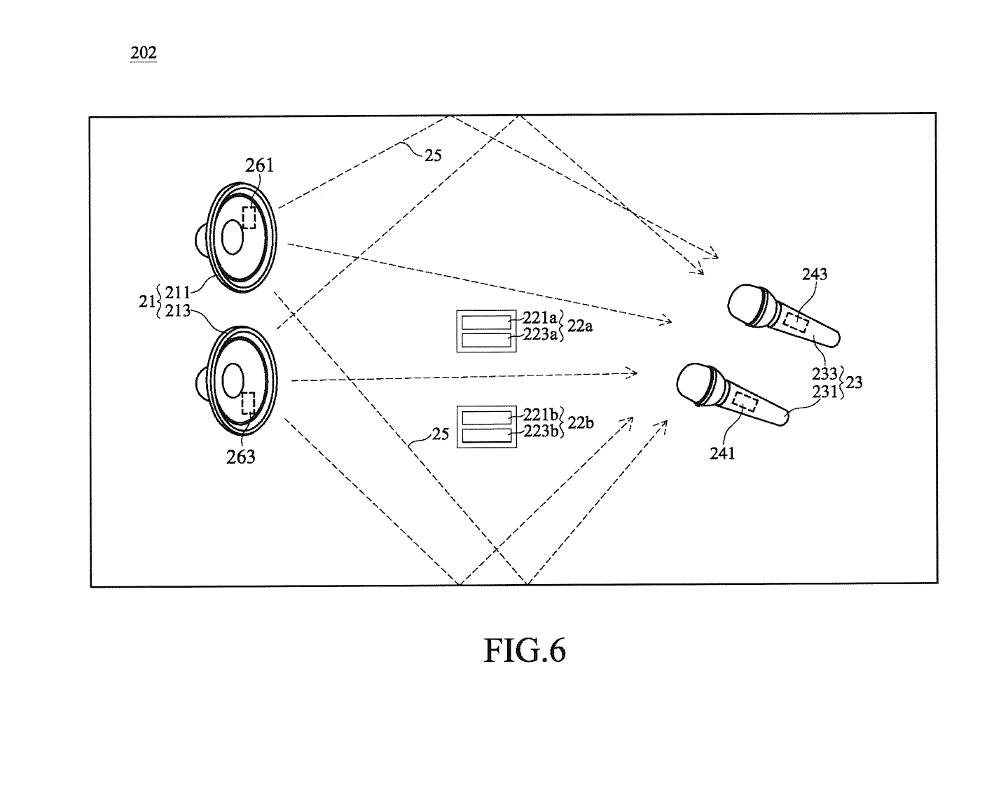

Please referring to FIG. 6, it shows a block diagram of a system for acoustic channel information detection in accordance with another embodiment of the present invention. As illustrated, the detection system 202 comprises, but not limited to, a plurality of speakers 21 and a plurality of microphones 23, wherein speakers 21 and microphones 23 are located in an environment 20, such as room, automobile interior or open space. Speakers 21 are capable of generating at least one acoustic signal, and microphones 23 are capable of receiving at least one acoustic signal.

In this embodiment of the invention, speakers 21 are able to generate same or different CDMA modulated audio training signals 22 at the same time, and the microphones 23 are able to receive CDMA modulated audio training signals 22 from speakers 21 via a plurality of acoustic channels 25. Thus, the acoustic channel information of speakers 21 and microphones 23 can be estimated.

In one embodiment of the invention, speakers 21 comprise, but not limited to, a first speaker 211 and a second speaker 213, and microphones 23 comprise, but not limited to, a first microphone 231 and a second microphone 233. The first speaker 211 is able to generate a first CDMA modulated audio training signal 22a, and the second speaker 213 is able to generate a second CDMA modulated audio training signal 22b. Please referring to FIG. 4, the first CDMA modulated audio training signal 22a comprises, but not limited to, a first data signal 221a and a first spreading code 223a, wherein the first spreading code 223a is used to modulate the first data signal 221a. The second CDMA modulated audio training signal 22b comprises, but not limited to, a second data signal 221b and a second spreading code 223b, wherein the second spreading code 223b is used to modulate the second data signal 221b. The first microphone 231 comprises the first spreading code 223a to demodulate the received first CDMA modulated audio training signal 22a and the received second CDMA modulated audio training signal 22b to generate the first data signal 221a, wherein the second CDMA modulated audio training signal 22b will be filtered. Thus, the acoustic channel information between the first speaker 211 and the first microphone 231 can be estimated. Further, the second microphone 233 comprises the second spreading code 223b to demodulate the received first CDMA modulated audio training signal 22a and the received second CDMA modulated audio training signal 22b to generate the second data signal 221b, wherein the first CDMA modulated audio training signal 22a will be filtered. Thus, the acoustic channel information between the second speaker 213 and the second microphone 233 can be estimated.

Furthermore, the first speaker 211 is able to generate the second CDMA modulated audio training signal 22b, and the second speaker 213 is able to generate the first CDMA modulated audio training signal 22a. Thus, the acoustic channel information between the first speaker 211 and the second microphone 233, and the acoustic channel information between the second speaker 213 and the first microphone 231 also can be estimated at the same time.

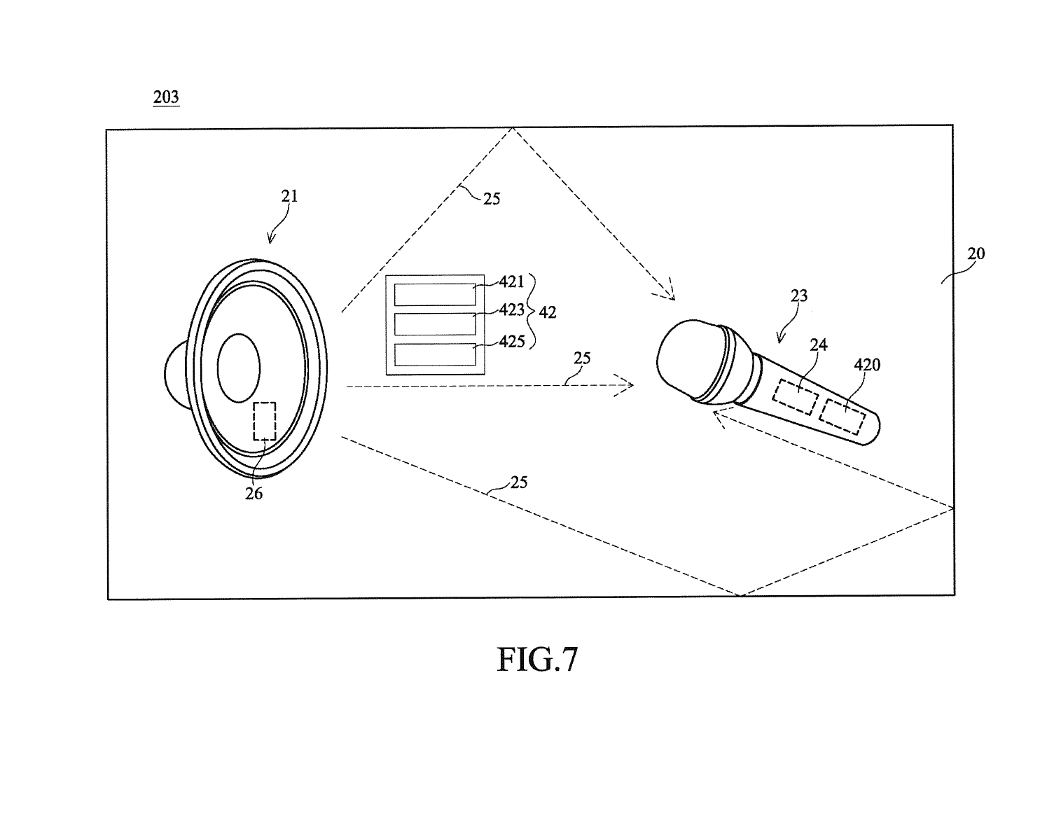

Please referring to FIG. 7, it shows a block diagram of a system for acoustic channel information detection in accordance with another embodiment of the present invention. As illustrated, the detection system 203 comprises, but not limited to, at least one speaker 21 and at least one microphone 23, wherein the speaker 21 and the microphone 23 are located in an environment 20, such as room, automobile interior or open space. The speaker 21 is capable of generating at least one acoustic signal, and the microphone 23 is capable of receiving at least one acoustic signal.

There are multi-acoustic channels 25 between the speaker 21 and the microphone 23 within an environment 20. During detection of the acoustic channel information between the speaker 21 and the microphone 23 within the environment 20, the speaker 21 generates a CDMA modulated audio training signal 42, and the microphone 23 receives the CDMA modulated audio training signal 42 from the speaker 21 via a plurality of acoustic channels 25 within the environment 20.

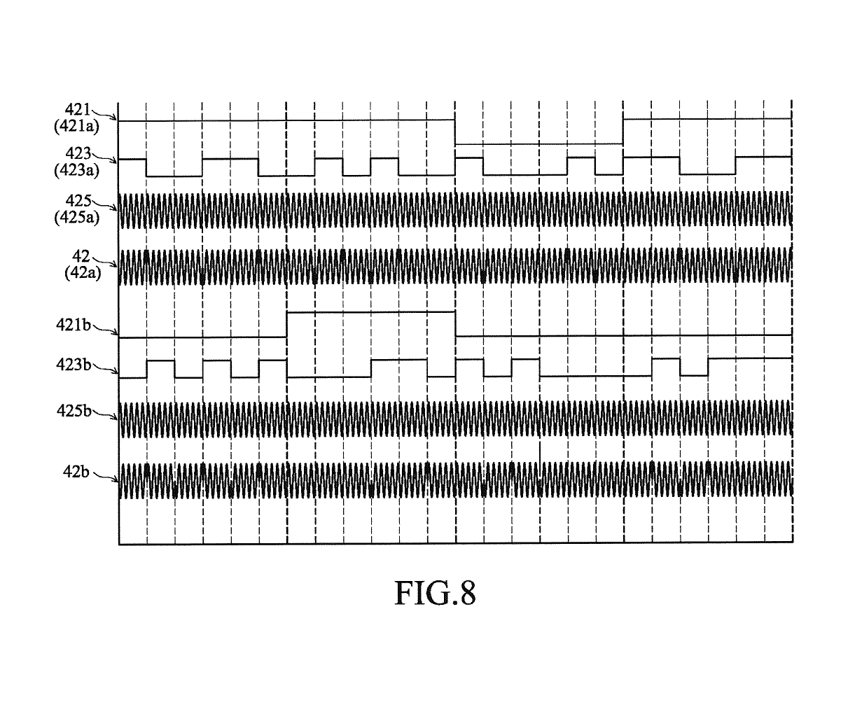

In this embodiment of the invention, please referring to FIG. 8, the CDMA modulated audio training signal 42 comprises, but not limited to, a data signal 421, a spreading code 423 and a continuous frequency code 425, wherein the frequency range of the continuous frequency code 425 is human ear hearing range, such as between 10 Hz to 20 kHz. The CDMA modulated audio training signal 42 and/or the continuous frequency code 425 can be an audible audio signal or an inaudible audio signal. For example, the signal energy of the CDMA modulated audio training signal 42 and the continuous frequency code 425 are below the noise floor and inaudible to human ear. The CDMA modulated audio training signal 42 is a pre-known signal for the microphone 23 and/or the speaker 21. For example, the microphone 23 and/or the speaker 21 comprise a pre-know CDMA modulated audio training signal 420.

In one embodiment of the invention, the speaker 21 modulates the data signal 421 by the spreading code 423 and the continuous frequency code 425 to generate the CDMA modulated audio training signal 42, and the microphone 23 demodulates the CDMA modulated audio training signal 42 transmitted from the speaker 21 via a plurality acoustic channels 25 by the spreading code 423 and the continuous frequency code 425 to form the data signal 421. Thus, the microphone 23 is capable of estimating the acoustic channel information within the environment 20 by comparing the demodulated CDMA modulated audio training signal 42 with the pre-known CDMA modulated audio training signal 420.

In one embodiment of the invention, the speaker 21 may comprise, but not limited to, a CDMA modulation unit 26 that is able to modulate the data signal 421 by the spreading code 423 and the continuous frequency code 425 to generate the CDMA modulated audio training signal 42. Further, the microphone 23 may comprise, but not limited to, a rake receiver 24, wherein the rake receiver 24 is able to demodulate the received CDMA modulated audio training signal 42 to know the phase and the phase delay of the received CDMA modulated audio training signal 42. For example, the rake receiver 24 comprises a plurality of same spreading codes 433, and a plurality of continuous frequency codes 425 with different phase, and only one of spreading codes 433 and continuous frequency codes 425 are capable of demodulating the received CDMA modulated audio training signal 42. Thereafter, the rake receiver 24 is able to know the phase and the phase delay of the received CDMA modulated audio training signal 42 according to the spreading code 433 and the continuous frequency code 425 that are used to demodulate the received CDMA modulated audio training signal 42.

In this embodiment, the CDMA modulated audio training signal 42 comprises the continuous frequency code 425, and the microphone 23 receives the CDMA modulated audio training signal 42 with the continuous frequency code 425 from the speaker 21 via a plurality of acoustic channels 25 within the environment 20 to estimate the frequency dependent channel information, such as frequency response mismatch and echo, and do the necessary equalization accordingly.

Moreover, the microphone 23 is able to estimate the echo, such as linear echo, of acoustic channels 25 within the environment 20, and do echo cancellation according to the acoustic channel information.

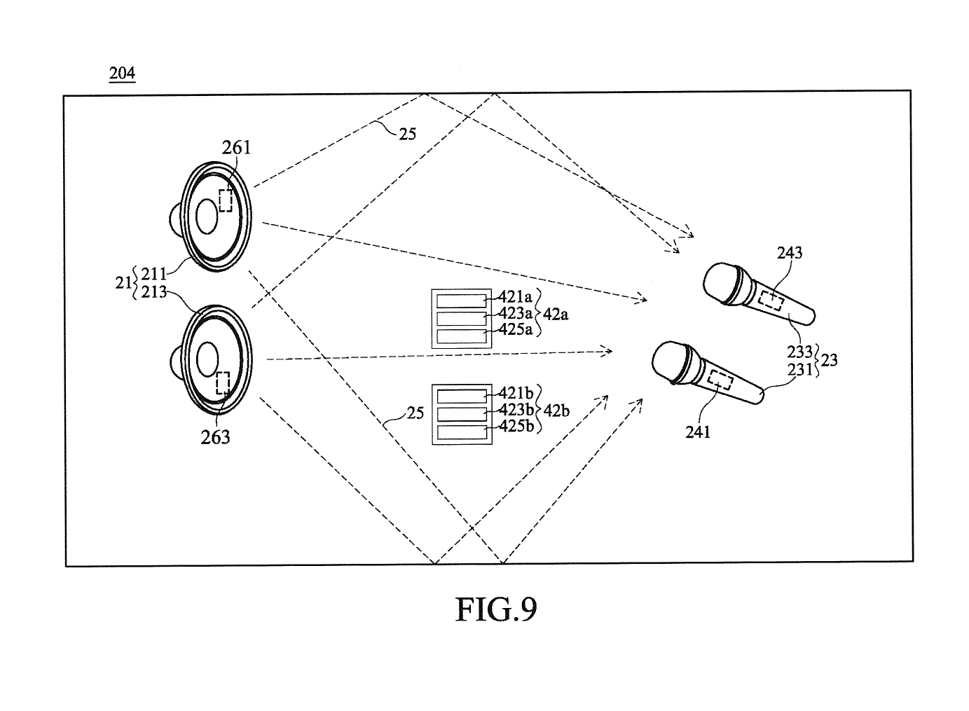

Please referring to FIG. 9, it shows a block diagram of a system for acoustic channel information detection in accordance with another embodiment of the present invention. As illustrated, the detection system 204 comprises, but not limited to, a plurality of speakers 21 and a plurality of microphones 23, wherein speakers 21 and microphones 23 are located in an environment 20, such as room, automobile interior or open space. Speakers 21 are capable of generating at least one acoustic signal, and microphones 23 are capable of receiving at least one acoustic signal.

In this embodiment of the invention, speakers 21 are able to generate same or different CDMA modulated audio training signals 22 at the same time, and microphones 23 are able to receive CDMA modulated audio training signals 22 from speakers 21 via a plurality of acoustic channels 25. Thus, the acoustic channel information of speakers 21 and microphones 23 can be estimated.

In one embodiment of the invention, speakers 21 comprise, but not limited to, a first speaker 211 and a second speaker 213, and microphones 23 comprise, but not limited to, a first microphone 231 and a second microphone 233. Please referring to FIG. 8, the first speaker 211 is able to generate a first CDMA modulated audio training signal 42a, and the second speaker 213 is able to generate a second CDMA modulated audio training signal 42b. The first CDMA modulated audio training signal 42a comprises, but not limited to, a first data signal 421a, a first spreading code 423a and a first continuous frequency code 425a, wherein the first spreading code 423a and the first continuous frequency code 425a are used to modulate the first data signal 421a. The second CDMA modulated audio training signal 42b comprises, but not limited to, a second data signal 421b, a second spreading code 423b, and a second continuous frequency code 425b, wherein the second spreading code 423b and the second continuous frequency code 425b are used to modulate the second data signal 421b. The first microphone 231 comprises the first spreading code 423a and the first continuous frequency code 425a to demodulate the received first CDMA modulated audio training signal 42a and the received second CDMA modulated audio training signal 42b to generate the first data signal 421a, wherein the second CDMA modulated audio training signal 42b will be filtered. Thus, the acoustic channel information between the first speaker 211 and the first microphone 231 can be estimated. Further, the second microphone 233 comprises the second spreading code 423b and the second continuous frequency code 425b to demodulate the received first CDMA modulated audio training signal 42a and the received second CDMA modulated audio training signal 42b to generate the second data signal 421b, wherein the first CDMA modulated audio training signal 42a will be filtered. Thus, the acoustic channel information between the second speaker 213 and the second microphone 233 can be estimated.

Furthermore, the first speaker 211 is able to generate the second CDMA modulated audio training signal 42b, and the second speaker 213 is able to generate the first CDMA modulated audio training signal 42a. Thus, the acoustic channel information between the first speaker 211 and the second microphone 233, and the acoustic channel information between the second speaker 213 and the first microphone 231 also can be estimated at the same time.

In one embodiment of the invention, each speaker 21 may comprises, but not limited to, a CDMA modulation unit 261/263, wherein the CDMA modulation unit 261/263 is able to modulate the data signal 421a/421b by the spreading code 423a/423b and the continuous frequency code 425a/425b to generate the CDMA modulated audio training signal 42a/42b. Further, each microphone 23 may comprises, but not limited to, a rake receiver 241/243, wherein the rake receiver 241/243 is able to demodulate the received CDMA modulated audio training signal 42a/42b to know the phase and the phase delay of the received CDMA modulated audio training signal 42a/42b.

Accurate acoustic MIMO channel estimation, such as phase, frequency response, multi-path, enables more accurate active noise cancellation, even in an open environment.

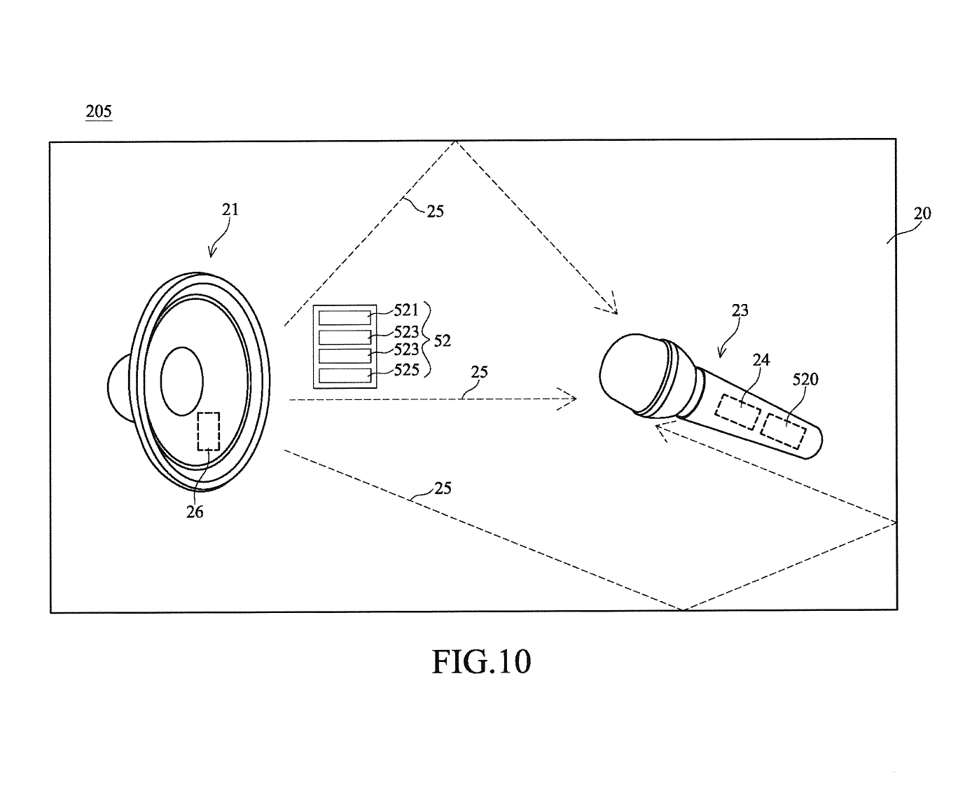

Please referring to FIG. 10, it shows a block diagram of a system for acoustic channel information detection in accordance with another embodiment of the present invention. As illustrated, the detection system 205 comprises at least one speaker 21 and at least one microphone 23, wherein the speaker 21 and the microphone 23 are located in an environment 20, such as room, automobile interior or open space. The speaker 21 is capable of generating at least one acoustic signal, and the microphone 23 is capable of receiving at least one acoustic signal.

There are multi-acoustic channels 25 between the speaker 21 and the microphone 23 within the environment 20. During detection of the acoustic channel information, the speaker 21 generates a CDMA modulated audio training signal 52, and the microphone 23 receives the CDMA modulated audio training signal 52 via a plurality of acoustic channels 25 within the environment 20.

The CDMA modulated audio training signal 52 is a pre-known signal for the microphone 23 and/or the speaker 21. For example, the microphone 23 and/or the speaker 21 comprise a pre-know CDMA modulated audio training signal 520.

In this embodiment of the invention, the CDMA modulated audio training signal 52 comprises a data signal 521, a plurality of orthogonal spreading codes 523 and a continuous frequency code 525, wherein the frequency range of the continuous frequency code 525 is human ear hearing range, such as between 10 Hz to 20 kHz. Moreover, the CDMA modulated audio training signal 52 and/or the continuous frequency code 525 can be an audible audio signal or an inaudible audio signal. For example, the signal energy of the CDMA modulated audio training signal 52 and the continuous frequency code 525 are below the noise floor and inaudible to human ear.

The speaker 21 modulates the data signal 521 by a plurality of orthogonal spreading codes 523 and a continuous frequency code 525 to generate the CDMA modulated audio training signal 52, and the microphone 23 demodulates the CDMA modulated audio training signal 52 transmitted by the speaker 21 via a plurality acoustic channels 25 by a plurality of orthogonal spreading codes 523 and a continuous frequency code 525 to form the data signal 521. Thus, the microphone 23 is capable of estimating the acoustic channel information within the environment 20 by comparing the demodulated CDMA modulated audio training signal 52 with the pre-known CDMA modulated audio training signal 520.

In this embodiment, the CDMA modulated audio training signal 52 comprises a plurality of orthogonal spreading codes 523, and the microphone 23 receives the CDMA modulated audio training signal 52 with a plurality of orthogonal spreading codes 523 from the speaker 21 via a plurality of acoustic channels 25 within the environment 20 to calculate the nonlinearly echo of acoustic channels 25 within the environment 20, and do nonlinearly echo cancellation accordingly to improve the voice quality of the speaker 21 and the microphone 23. For example, as the CDMA modulated audio training signal 52 comprises two orthogonal spreading codes 523, the X² nonlinearly echo can be estimated.

In one embodiment of the invention, the speaker 21 may comprise, but not limited to, a CDMA modulation unit 26 that is able to modulate the data signal 521 by the spreading code 523 and the continuous frequency code 525 to generate the CDMA modulated audio training signal 52. Further, the microphone 23 may comprise, but not limited to, a rake receiver 24, wherein the rake receiver 24 is able to demodulate the received CDMA modulated audio training signal 52 to know the phase and the phase delay of the received CDMA modulated audio training signal 52 according to the spreading code 523 and the continuous frequency code 525 used to demodulate the received CDMA modulated audio training signal 52.

It is to be understood the invention is not limited to particular systems or methods described which may, of course, vary. It is also to be understood that the terminology used herein is for the purpose of describing particular embodiments only, and is not intended to be limiting. As used in this specification, the singular forms “a”, “an” and “the” include plural referents unless the content clearly indicates otherwise. Thus, for example, reference to “a device” includes a combination of two or more devices and reference to “a material” includes mixtures of materials.

Further modifications and alternative embodiments of various aspects of the invention will be apparent to those skilled in the art in view of this description. Accordingly, this description is to be construed as illustrative only and is for the purpose of teaching those skilled in the art the general manner of carrying out the invention. It is to be understood that the forms of the invention shown and described herein are to be taken as the presently preferred embodiments. Elements and materials may be substituted for those illustrated and described herein, parts and processes may be reversed, and certain features of the invention may be utilized independently, all as would be apparent to one skilled in the art after having the benefit of this description of the invention. Changes may be made in the elements described herein without departing from the spirit and scope of the invention as described in the following claims.

What is claimed is:

1. A system for acoustic channel information detection, comprising:
at least one speaker located in an environment for transmitting a CDMA modulated audio training signal; and
at least one microphone located in said environment for receiving said CDMA modulated audio training signal from said speaker via at least one acoustic channel within said environment to estimate an acoustic channel information according to said received CDMA modulated audio training signal.

2. The system as claimed in claim 1, wherein said microphone comprises a pre-known CDMA modulated audio training signal, and said microphone compares said received CDMA modulated audio training signal with said pre-know CDMA modulated audio training signal to estimate said acoustic channel information.

3. The system as claimed in claim 1, wherein said CDMA modulated audio training signal comprises a data signal and a spreading code.

4. The system as claimed in claim 3, wherein said speaker uses said spreading code to modulate said data signal to form said CDMA modulated audio training signal, and said microphone uses said spreading code to demodulate said received CDMA modulated audio training signal.

5. The system as claimed in claim 1, wherein said CDMA modulated audio training signal comprises a data signal, a spreading code and a continuous frequency code.

6. The system as claimed in claim 5, wherein said speaker uses said spreading code and said continuous frequency code to modulate said data signal to form said CDMA modulated audio training signal, and said microphone uses said spreading code and said continuous frequency code to demodulate said received CDMA modulated audio training signal.

7. The system as claimed in claim 1, wherein said CDMA modulated audio training signal comprises a data signal, a plurality of orthogonal spreading codes and a continuous frequency code.

8. The system as claimed in claim 7, wherein said speaker uses said orthogonal spreading codes and said continuous frequency code to modulate said data signal to form said CDMA modulated audio training signal, and said microphone uses said orthogonal spreading codes and said continuous frequency code to demodulate said received CDMA modulated audio training signal.

9. The system as claimed in claim 1, wherein the signal energy of said CDMA modulated audio training signal is below the noise floor and inaudible to human ear, or audible to human ear.

10. The system as claimed in claim 2, wherein said speaker transmits said pre-know CDMA modulated audio training signal to said microphone by wire or wireless.

11. The system as claimed in claim 1, wherein said microphone comprises a rake receiver to demodulate said received CDMA modulated audio training signal to know the phase and the phase delay of said received CDMA modulated audio training signal.

12. The system as claimed in claim 2, wherein said speaker transmits said CDMA modulated audio training signal and an acoustic signal at the same time, said microphone receives said CDMA modulated audio training signal and said acoustic signal and filters said acoustic signal, and said microphone compares said received CDMA modulated audio training signal with said pre-know CDMA modulated audio training signal to estimate said acoustic channel information

13. A method for acoustic channel information detection, wherein there are at least one microphone, at least one speaker and a plurality of acoustic channels within an environment, comprising steps of:
transmitting a CDMA modulated audio training signal from said speaker;
receiving said CDMA modulated audio training signal by said microphone from said speaker via said acoustic channels; and
estimating an acoustic channel information according to said received CDMA modulated audio training signal.

14. The method as claimed in claim 13, wherein said microphone comprises at least one pre-known CDMA modulated audio training signal, and said microphone compares said received CDMA modulated audio training signal with said pre-know CDMA modulated audio training signal to estimate said acoustic channel information.

15. The method as claimed in claim 13, wherein said CDMA modulated audio training signal comprises a data signal and a spreading code.

16. The method as claimed in claim 15, further comprising steps of:
modulating said data signal by said spreading code to form said CDMA modulated audio training signal; and
demodulating said received CDMA modulated audio training signal by said spreading code.

17. The method as claimed in claim 13, wherein said CDMA modulated audio training signal comprises a data signal, a spreading code and a continuous frequency code.

18. The method as claimed in claim 17, further comprising steps of:
modulating said data signal by said spreading code and said continuous frequency code to form said CDMA modulated audio training signal; and
demodulating said received CDMA modulated audio training signal by said spreading code and said continuous frequency code.

19. The method as claimed in claim 13, wherein said CDMA modulated audio training signal comprises a data signal, a plurality of orthogonal spreading codes and a continuous frequency code.

20. The method as claimed in claim 19, further comprising steps of:
modulating said data signal by said a plurality of orthogonal spreading codes and said continuous frequency code to form said CDMA modulated audio training signal; and
demodulating said received CDMA modulated audio training signal by said a plurality of orthogonal spreading codes and said continuous frequency code.

21. The method as claimed in claim 13, wherein the signal energy of said CDMA modulated audio training signal is below the noise floor and inaudible to human ear, or audible to human ear.

22. The method as claimed in claim 13, wherein said microphone comprises a rake receiver to demodulate said received CDMA modulated audio training signal to know the phase and phase delay of said received CDMA modulated audio training signal.

23. The method as claimed in claim 14, further comprising steps of:
transmitting said CDMA modulated audio training signal and an acoustic signal from said speaker;
receiving said CDMA modulated audio training signal and said acoustic signal by said microphone from said speaker via said acoustic channels;
filtering said acoustic signal; and
comparing said received CDMA modulated audio training signal with said pre-know CDMA modulated audio training signal to estimate said acoustic channel information.
